(19) United States
(12) Patent Application Publication
(10) Pub. No.: US 2006/0252295 A1
(43) Pub. Date: Nov. 9, 2006

(54) Quick lamp connector

(76) Inventors: Vincent Mazzarelli, Sayreville, NJ (US); Diana Mazzarelli, Sayreville, NJ (US)

Correspondence Address: JAMES RAY & ASSOCIATES, 2640 PITCAIRN ROAD, MONROEVILLE, PA, 15146, US

(21) Appl. No.: 11/393,469

(22) Filed: Mar. 30, 2006

Related U.S. Application Data
(60) Provisional application No. 60/668,007, filed on Apr. 4, 2005.

(51) Int. Cl. H01R 13/627

(52) U.S. Cl. 439/353

(57) ABSTRACT

A quick connector for a lamp used in combination with a threaded socket includes a hollow housing and a base member connected to one end of the hollow housing. A plurality of spaced arms are resiliently engageable with the housing and movable thereto for enabling insertion and removal of the connector in a substantially axial direction and in a rotation free fashion. Such arms conduct electricity from the socket. A terminal dielectrically mounted in a center of the base member for electrical contact with a base contact of such socket is provided for conducting electrical current when the connector is inserted into such socket.

### CROSS-REFERENCE TO RELATED APPLICATIONS

This application is related to and claims priority from Provisional Patent Application Ser. No. 60/668,007 filed Apr. 4, 2005.

### FIELD OF THE INVENTION

The present invention relates, in general, to lamps and light bulbs and, more particularly, this invention relates to a mounting arrangement for lamps and light bulbs enabling their installation and removal in a rotation free fashion.

### BACKGROUND OF THE INVENTION

As is generally well known, conventional lamps for example such as light bulbs, employ threaded bases which are conductively screwed, by way of rotation, into respective conductive sockets. Quite often, problems arise with installing or removing light bulbs. The light bulb may become stuck in a threaded socket when being rotated, requiring a user to unscrew it and repeat the installation process. At times, the user may make three or four attempts until a light bulb goes in correctly. During these attempts, the glass of the light bulb can break, possibly injuring such user.

Additionally, users with any type of arthritis, neurological or muscular disorder or just a generalized weakness in their hands generally experience difficulties in changing standard light bulbs.

Other difficulties exist in changing light bulbs which are partially concealed by a surrounding glass fixture, as in example of a ceiling fan light, or which are mounted at a greater distance, for example, a recess lighting, due to limited ability by the user to view the alignment of the threads.

Efforts have been made to alleviate difficulties associated with installing and removing light bulbs by way of rotation.

U.S. Pat. No. 3,215,972 and U.S. Pat. No. 3,056,941, both to Eriksson disclose a connector or lamp base including a shell adhered to a glass lamp envelope, a support member attached to the interior portion of the shell, a spider mounted on such support within the shell and a base contact. The spider has arms protruding through apertures formed in the shell for engaging threads of the socket. The spider and the socket provide two electrical connections for the lamp. While the connector enables only axial movement and eliminates rotation, the need for a separate and complex spider and its support increases manufacturing costs of such connector.

U.S. Pat. No. 4,886,994 to Ragge, Jr. teaches a snap-in light bulb having a bulb through which light may be transmitted, a base connected to the bulb, and at least one arm resiliently connected to the base. The arm has a conductor element disposed for contact with a conductive light bulb socket and a plurality of spaced lobes that engage the socket threads. The disadvantage of such light bulb is that the base of such light bulb incorporates a recess, to temporarily receive such at least one arm during insertion, which requires a modification of a conventional bulb envelope in order to accommodate such recess.

U.S. Pat. No. 5,171,292 to Ortiz discloses an electric light bulb and socket system which includes a bulb with a base having a substantially cylindrical wall and a single groove extending into and about it and also includes a socket base with an open cavity therein and retaining springs for retaining the bulb. The retaining springs are mounted within the wall of the socket base, except for the lugs of the retaining springs which extend into the socket base cavity. The lugs of the retaining springs are dimensioned to, upon the insertion of the bulb into the receptacle, protrude into the groove and to seat therein. As the lugs are equally spaced about the groove, the lugs exert a balanced spring pressure on the bulb to retain the bulb in the socket. While, the installation and removal of the bulb into the socket is by axial movement without orientation and without rotation thereof, the bulb cannot be used with a conventional threaded socket limiting its use only to new installations.

### SUMMARY OF THE INVENTION

According to one embodiment of the invention, there is provided a quick connector for a lamp used in combination with a socket having a generally helical thread formed on an inner wall surface thereof. Such connector includes a hollow housing member having a first end which is disposed towards a portion of such lamp having a peripheral wall which is capable of emitting one of a light, heat and radiation. A base member is engageable with an opposed second end of the hollow housing member. A plurality of arms are resiliently engageable with the housing member and are disposed in a spaced relationship to each other. The plurality of arms are movable towards an exterior surface of the housing member for enabling insertion and removal of the connector in a substantially axial direction and in a rotation free fashion. The arms are movable outwardly from the exterior surface of the housing member for engagement with such generally helical thread. The engagement secures the connector within such socket and enables the plurality of arms to conduct electrical current when the connector is inserted into such socket. A terminal is mounted in a center of the base member for electrical contact with a base contact of such socket for conducting electrical current when the connector is inserted into such socket. The terminal is disposed in a dielectric relationship with one of the housing member, the plurality of arms and a combination thereof.

According to another embodiment, the invention provides a lamp employing such quick connector and further employing a collar disposed intermediate the housing member and the portion of the lamp which is capable of emitting one of a light, heat and radiation.

### OBJECTS OF THE INVENTION

It is, therefore, one of the primary objects of the present invention to provide a lamp that is mountable into a conventional threaded socket.

Another object of the present invention is to provide a lamp which is easily mountable into a conventional threaded socket without the need for rotation.

Yet another object of the present invention is to provide a lamp which is securely mountable into a conventional threaded socket.

A further object of the present invention is to provide a lamp mountable into a conventional threaded socket that is inexpensive to manufacture.

Yet a further object of the present invention is to provide a lamp mountable into a conventional threaded socket which employs a conventional glass bulb envelope.

Still a further object of the present invention is to provide a mounting arrangement for a lamp mountable into a conventional threaded socket that is electrically conductive.

An additional object of the present invention is to provide a mounting arrangement for a lamp mountable into a conventional threaded socket that is resistive to electrical shorts.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is an elevation view, partially in cross-section, of a lamp and a quick connector according to one embodiment of the present invention;

FIG. 2 is a partial elevation view of the lamp and the quick connector of FIG. 1, showing the resilient arm construction; and

FIG. 3 is an elevation view, partially in cross-section, of a lamp and a quick connector according to another embodiment of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a lamp applies to an artificial source of including but not limited to light, heat, and radiation, particularly for therapeutic purposes.

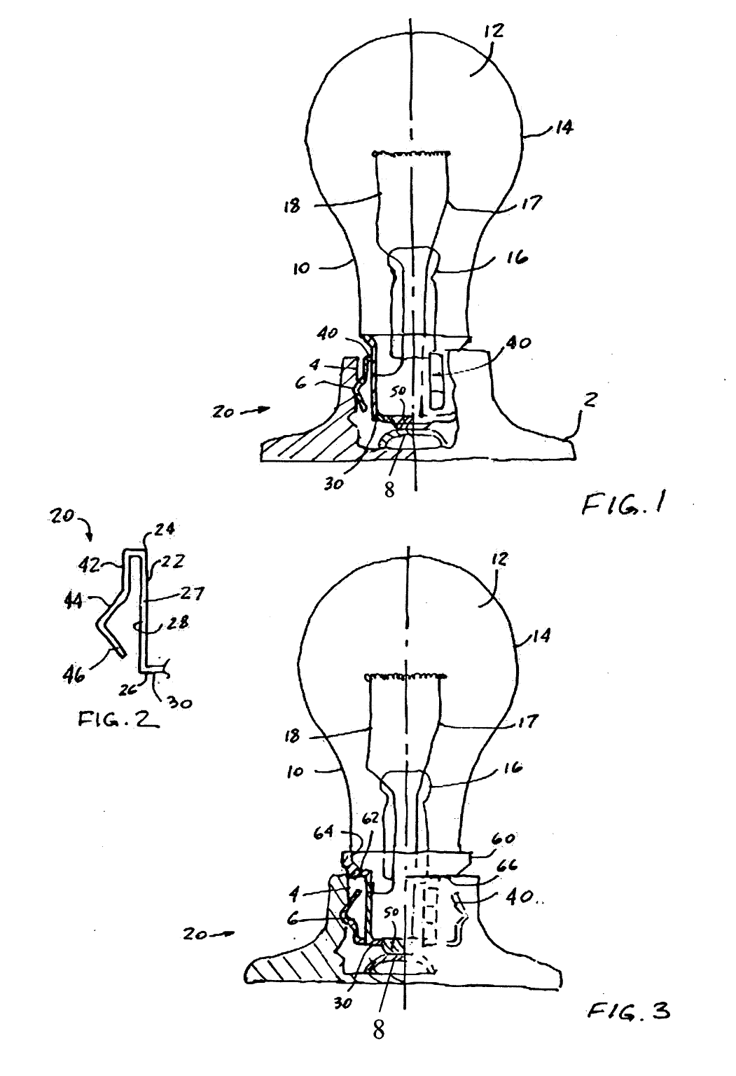

Now reference is now made, to FIGS. 1-3. Shown therein is a lamp 10 used in combination with a socket 2 having a generally helical thread 6 formed on an inner wall surface 4 thereof. The lamp 10 includes a portion 12 which has a peripheral wall 14 capable of emitting one of light, heat, and radiation and a means 16 which is capable of generating such one of light, heat, and radiation. By way of example in FIGS. 1 and 3, lamp 10 is illustrated as an incandescent light bulb wherein the emitting portion 12 is a globe having a substantially spherical envelope.

A connector, generally designated as 20, for such lamp 10 includes a hollow housing member 22 having a first end 24 disposed towards such emitting portion 12. Preferably, the housing member 22 includes a generally cylindrical wall 27. A base member 30 is connected to a second end 26 of the hollow housing member 22.

A plurality of arms 40 are provided in resilient engagement with the housing member 22 and in a spaced relationship to each other. The arms 40 are resiliently movable towards an exterior surface 28 of the housing member 22 for enabling insertion and removal of the connector 20 in a substantially axial direction and in a rotation free fashion. The arms 40 are movable outwardly from the exterior surface 28 of the housing member 22 for engagement with such generally helical thread 6 of the socket 2. Such engagement secures the connector 20 within such socket 10 and enables the plurality of arms 40 to conduct electrical current when the connector 20 is inserted into such socket 10. Preferably, the plurality of arms 40 are formed integral to the housing member 22.

In the presently preferred embodiment of the present invention each arm 40 includes a first section 42 which is attached to a predetermined portion of the housing member 22 and extends generally parallel to the exterior surface 28 of the housing member 22. An intermediate section 44 is connected to the first section 42 at a first predetermined angle and extends outwardly from the exterior surface 28 of the housing member 22. An end section 46 is connected to the intermediate section 44 at a second predetermined angle and extends towards the exterior surface 28 of the housing member 22. The first section 42 of the arm 40 may be attached to one of the first end 24 and the second end 26 of the housing member 22 and the end section 46 therefore extending towards an opposed one of the first and the second end 24 and 26, respectively, of the housing member 22.

A terminal 50 is mounted in a center of the base member 30 and is in electrical contact with a base contact 8 of such socket 2 for conducting electrical current when the connector 20 is inserted into such socket 2. The terminal 50 is further disposed in a dielectric relationship with one of the housing member 22, the plurality of arms 40 and a combination thereof in order to eliminate electrical shorts.

Furthermore, the base member 30 may be one of secured to the housing member 22 with the use of a heat resistant adhesive, typically used in the conventional light bulb manufacturing, and formed integral to the housing member 22. It will be understood that when the housing member 22 is made from electrically conducting material, such base member 30 is made from a dielectric material, such as thermoplastic, which is also resistant to heat.

In one embodiment of the invention, the first end 22 may include a flared portion 23 for direct attachment to such emitting portion 12 of such lamp 10 with the use of a heat resistant adhesive.

In another embodiment of the invention, the connector 20 further includes a collar 60 with an aperture 62 formed therein for attachment to the second end 26 of the housing member 22 and is further provided with a tapered annular portion 64 for attachment to such emitting portion 12 of such lamp 10. Advantageously, the collar 60 controls insertion of the connector 20 into such threaded socket 2 by way of its bottom surface 66 abutting the edge of the socket 2. Preferably, the collar 60 is formed from a dielectric material.

Generating means 16 may be any device capable of generating one of a light, heat and radiation and generally includes a first electrode 17 which is connected to the terminal 50 and a second electrode 18 which is connected to one of the housing member 22 and at least one of the plurality of arms 40.

Although the present invention has been shown in terms of the Edison style incandescent light bulb, it will be apparent to those skilled in the art, that the present invention may be applied to other lamps capable of generating and emitting light, heat and radiation. One example of such lamp may be a high intensity discharge (HID) lamp which generates light by striking an electrical arc across tungsten electrodes housed inside a specially designed inner fused quartz or fused alumina tube.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A quick connector for a lamp used in combination with a socket having a generally helical thread formed on an inner wall surface thereof, said connector comprising:
(a) a hollow housing member having a first end disposed towards a portion of such lamp having a peripheral wall which is capable of emitting one of a light, heat and radiation;
(b) a base member engageable with an opposed second end of said hollow housing member;
(c) a plurality of arms resiliently engageable with said housing member and disposed in a spaced relationship to each other, said plurality of arms movable towards an exterior surface of said housing member for enabling insertion and removal of said connector in a substantially axial direction and in a rotation free fashion and movable outwardly from said exterior surface of said housing member for engagement with such generally helical thread, said engagement secures said connector within such socket and enables said plurality of arms to conduct electrical current when said connector is inserted into such socket; and
(d) a terminal mounted in a center of said base member for electrical contact with a base contact of such socket for conducting electrical current when said connector is inserted into such socket, said terminal being disposed in a dielectric relationship with one of said housing member, said plurality of arms and a combination thereof.

2. The connector, according to claim 1, wherein said housing member includes a generally cylindrical wall.

3. The connector, according to claim 1, wherein said plurality of arms are formed integral to said housing member.

4. The connector, according to claim 1, wherein each of said plurality of arms includes:
(a) a first section attached to a predetermined portion of said housing member and extending generally parallel to said exterior surface of said housing member;
(b) an intermediate section connected to said first section at a first predetermined angle and extending outwardly from said exterior surface of said housing member; and
(c) an end section connected to said intermediate section at a second predetermined angle and extending towards said exterior surface of said housing member.

5. The connector, according to claim 4, wherein said first section is attached to one of said first end and said second end of said housing member and said end section extends towards an opposed one of said first end and said second end of said housing member.

6. The connector, according to claim 1, wherein said base member is formed integral to said housing member.

7. The connector, according to claim 1, wherein said base member is made from a dielectric material.

8. The connector, according to claim 1, wherein said base member is made from a heat resistant material.

9. The connector, according to claim 1, wherein said first end is flared outwardly for direct attachment to such emitting portion of such lamp by way of a heat resistant adhesive.

10. The connector, according to claim 1, wherein said connector further includes a collar attached intermediate said first end of said housing member and such emitting portion of such lamp by way of a heat resistant adhesive.

11. The connector, according to claim 10, wherein said collar controls insertion of said connector into such threaded socket.

12. The connector, according to claim 10, wherein said collar is formed from a dielectric material.

13. A lamp for use in combination with a socket having a generally helical thread formed on an inner wall surface thereof, said lamp comprising:
(a) a hollow housing member having a first end and an opposed second end;
(b) a base member engageable with said second end of said hollow housing member;
(c) a plurality of arms resiliently engageable with said housing member and disposed in a spaced relationship to each other, said plurality of arms movable towards an exterior surface of said housing member for enabling insertion and removal of said connector in a substantially axial direction and in a rotation free fashion and movable outwardly from said exterior surface of said housing member for engagement with such generally helical thread, said engagement secures said connector within such socket and enables said plurality of arms to conduct electrical current when said connector is inserted into such socket;
(d) a terminal mounted in a center of said base member for electrical contact with a base contact of such socket for conducting electrical current when said connector is inserted into such socket, said terminal being disposed in a dielectric relationship with one of said housing member, said plurality of arms and a combination thereof;
(e) a collar securely attached to said first end of said housing member by way of a heat resistant adhesive;
(f) means securely and sealingly attached to said collar and having a peripheral wall capable of emitting one of a light, heat and radiation through it; and
(g) means disposed within said emitting means for generating said one of light, heat and radiation, said generating means having a first electrode connected to said terminal and having a second electrode connected to one of said housing member and at least one of said plurality of arms.

14. A lamp for use in combination with a socket having a generally helical thread formed on an inner wall surface thereof, said lamp comprising:
(a) a hollow housing member having a first end and an opposed second end;
(b) a base member engageable with said second end of said hollow housing member;
(c) a plurality of arms resiliently engageable with said housing member and disposed in a spaced relationship to each other, said plurality of arms movable towards an exterior surface of said housing member for enabling insertion and removal of said connector in a substantially axial direction and in a rotation free fashion and movable outwardly from said exterior surface of said housing member for engagement with such generally helical thread, said engagement secures said connector within such socket and enables said plurality of arms to conduct electrical current when said connector is inserted into such socket; each of said plurality of arms includes:
(i) a first section attached to a predetermined portion of said housing member and extending generally parallel to said exterior surface of said housing member,
(ii) an intermediate section connected to said first section at a first predetermined angle and extending outwardly from said exterior surface of said housing member, and
(iii) an end section connected to said intermediate section at a second predetermined angle and extending towards said exterior surface of said housing member;
(d) a terminal mounted in a center of said base member for electrical contact with a base contact of such socket for conducting electrical current when said connector is inserted into such socket, said terminal being disposed in a dielectric relationship with one of said housing member, said plurality of arms and a combination thereof;
(e) means securely and sealingly attached to said first end of housing member, said means having a peripheral wall capable of emitting one of a light, heat and radiation through it; and
(f) means disposed within said emitting means for generating said one of light, heat and radiation, said generating means having a first electrode connected to said terminal and having a second electrode connected to one of said housing member and at least one of said plurality of arms.
